(19) United States
(12) Patent Application Publication
(10) Pub. No.: US 2015/0254618 A1
(43) Pub. Date: Sep. 10, 2015

(54) Method for Facilitating Live Stream Feeds of Remote Locations, Events or Products, in a Social, Virtual Travel, or Business Setting

(71) Applicant: Krishna Shivaram, Torrance, CA (US)

(72) Inventor: Krishna Shivaram, Torrance, CA (US)

(21) Appl. No.: 14/641,029

(22) Filed: Mar. 6, 2015

Related U.S. Application Data
(60) Provisional application No. 61/949,892, filed on Mar. 7, 2014.

(51) Int. Cl. G06Q 20/14; G06Q 10/10; G06Q 20/40; G06Q 50/18; G06Q 10/06; G06Q 50/00; H04L 29/06; G06Q 30/06

(52) U.S. Cl. CPC G06Q 20/145; H04L 65/60; G06Q 10/1095; G06Q 30/0623; G06Q 40/02; G06Q 50/182; G06Q 10/0639; G06Q 50/01; G06Q 20/40

(57) ABSTRACT

A method for facilitating live feed streams of remote locations by communicably connecting a first electronic streaming device to a second electronic streaming device through a back-end system. A client user account is operated on the first electronic streaming device, while a streaming account is operated on the second electronic streaming device. A plurality of streaming events is displayed through the client user account, wherein a streaming selection can be made and an event appointment scheduled between the client user account and the streaming account. At the time of the event appointment, the client user account is communicably connected to the streaming account through the first electronic streaming device and the second electronic streaming device. A live stream video feed is then transmitted from the streaming account to the client user account, wherein the live stream video feed is viewed on the first electronic streaming device.

The current application claims a priority to the U.S. Provisional Patent application Ser. No. 61/949,892 filed on Mar. 7, 2014.

### FIELD OF THE INVENTION

The present invention relates generally to tourism. More specifically, the present invention is a system and method for electronic tourism that provides an improved customer experience and more secure payment methods.

### BACKGROUND OF THE INVENTION

While the concept is known to many, vacation time is not something which is available to all persons. Even amongst those who have vacation time, they may find it financially or even physically unfeasible to take a trip to a location of interest. The present invention, rather than bring the person to the location, brings the location to the person. Using the internet and audio-visual technology, a vacation experience is simulated and transmitted to a client user, allowing them to travel the world without leaving their living room.

The present invention provides a platform that connects users from across the world, allowing a client user to receive a live stream of a tour of a desired location. In this manner the present invention can substitute for a physical vacation or even aid with preparation and planning for a physical vacation. The present invention also applies improvements that build upon social media and payment processes that ultimately enhance electronic tourism. As an end result, the present invention is able to improve customer satisfaction and better obtain and retain an active user community.

A number of solutions have been attempted by others; a common example is a pre-recorded DVD or internet video that addresses an interesting location. However, these videos are often pre-planned and intended to attract tourists or enhance an area's reputation, further distorted by actions such as post-processing. Though some systems have been developed to overcome this by providing streaming tours, they do not provide the numerous advancements and benefits across a number of areas as provided by the present invention.

It is noted that the present invention was independently conceptualized and developed by the inventor; the creation was in no way influenced by prior art.

### BRIEF DESCRIPTION OF THE DRAWINGS

FIG. 1 is a flowchart depicting the steps for communicably connecting a client user account to a streaming account using the present invention;

FIG. 2 is a flowchart thereof, further depicting steps for charging a data rate charge to the streaming account; FIG. 3 is a flowchart thereof, further depicting steps for receiving a live stream video feed from a second electronic streaming device and displaying the live stream video feed on a first electronic streaming device;

FIG. 4 is a flowchart thereof, further depicting steps for receiving storage commands through the client user account in order to record the live stream video feed;

FIG. 5 is a flowchart thereof, further depicting steps for directly recording and storing the live stream video feed from the second electronic streaming device;

FIG. 6 is a flowchart thereof, further depicting steps for placing a tour fee in an escrow account and receiving a first rating from the client user account and a second rating from the streaming account;

FIG. 7 is a flowchart thereof, further depicting steps for transferring the tour fee to the streaming account if the first rating is above a satisfaction threshold;

FIG. 8 is a flowchart thereof, further depicting steps for an arbitration process if the first rating is below the satisfaction threshold;

FIG. 9 is a flowchart thereof, further depicting steps for a vetting process;

FIG. 10 is a flowchart thereof, further depicting steps for adding a event appointment to an events calendar;

FIG. 11 is a flowchart thereof, further depicting steps for uploading a media file through the client user account; and

FIG. 12 is a flowchart thereof, further depicting steps for requesting an event based on parameters provided by a client user.

FIG. 13 is a diagram depicting the first electronic device being communicably connected to the second electronic streaming device through a back-end system.

### DETAIL DESCRIPTIONS OF THE INVENTION

All illustrations of the drawings are for the purpose of describing selected versions of the present invention and are not intended to limit the scope of the present invention.

The present invention is a method for facilitating live stream feeds of remote locations. Through the implementation of the present invention, a user is able to visually and aurally experience foreign locations under the direction of a service-providing entity or subsequent user. While a distinction is made between client users and service-providing entities, client users may also act as service-providing entities; this allows client users of the present invention to provide guided tours in addition to contracting tours from professional service-providing entities and subsequent client users.

The primary benefit of the present invention is the ability for a client user to become an “e-Traveler” (which can also be referred to as an “e-Hopper” or “eHopper”); the present invention defines this as a person who experiences a remote location by receiving video and/or audio streams from a location of interest. The ability to become an e-Traveler is beneficial in a number of situations for varying reasons. For example, the client user may wish to visit the pyramids of Egypt but be unable due to poor health or insufficient funds to pay for the necessary travel and lodging. In another situation, the client user may be planning a vacation to Paris and desire to simulate the experience in order to prepare a better itinerary. In yet another scenario, the client user may be unable to physically attend an event such as wedding for a subsequent user due to insufficient funds or for health reasons. The present invention can also be used for remote business applications, such as viewing real estate locations or showcasing products such as cars, jewelry, etc. Client users may utilize the present invention for any purpose; the present invention is not limited to use in the aforementioned scenarios.

Through the present invention, the client user can choose from multiple streaming sources and create a schedule of events to stream. In order to do so, the client user must first establish a client user account that is used to remotely connect to a streaming account. The streaming account is associated with either a subsequent client user or service-providing entity and as such, the streaming account may more specifically be a subsequent client user account or a service provider account. The client user can create the client user account through a host software that is communicably coupled to a back-end system that is also used to store information relevant to the operation of the present invention. The back-end system can be any type of networking equipment, such as servers, routers, etc. In the preferred embodiment of the present invention, the host software is implemented as a website that is directly hosted on the back-end system. Alternatively, the host software may be a downloadable application that can be connected to the back-end system via the internet.

In order to establish the client user account, the client user must complete a registration process through the host software. During the registration process, the client user provides personal information that is submitted through the host software and stored on the back-end system. The personal information may include, but is not limited to, the name of the client user, a username, a password, email address, or payment information. Through account settings for the client user account, the client user can determine which information is displayed to other users of the host software. For example, the client user may be provided the option to display their name, initials, username, or a nickname to other users that are non-friends.

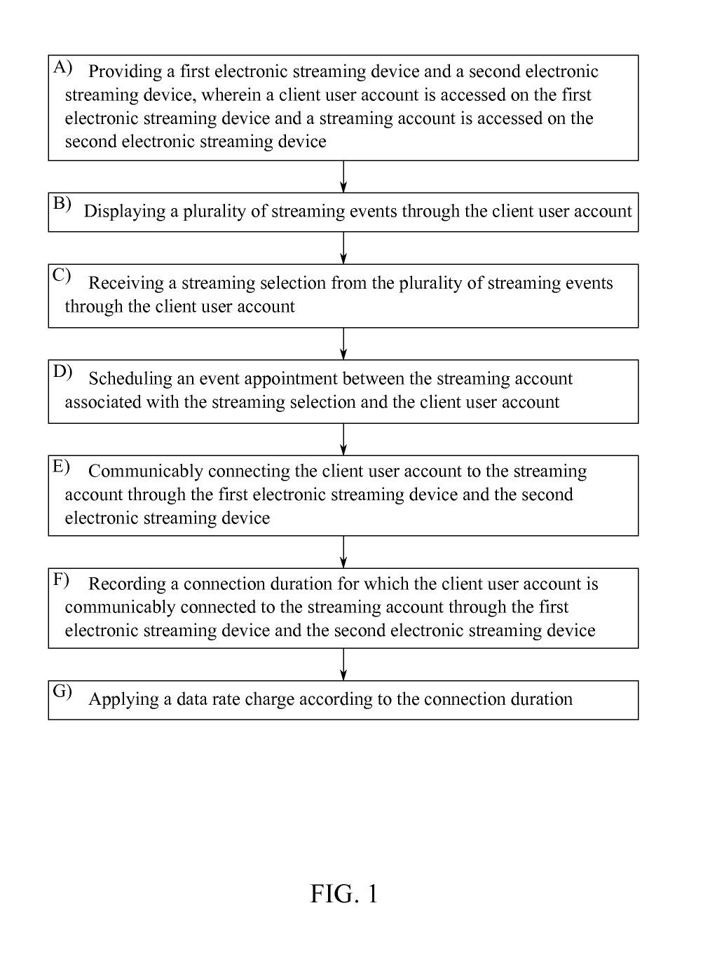

Once the client user has established the client user account, the client user is provided access to the functions of the present invention through the host software. The primary function of the present invention is to allow the client user to view remote locations through a live stream video feed. In reference to FIG. 1, the host software provides a search component that allows the client user to search through a plurality of streaming events, wherein the plurality of streaming events is displayed to the client user through the client user account. The client user can search for events from subsequent client users, such as weddings, birthday parties, etc., as well as events from service providing entities, such as tours, public business meetings, etc. By using the search component the client user can look for a streaming event that matches specific criteria or, provided the client user is flexible, look for more general streaming events that may of be interest.

The present invention provides a number of ways in which the client user is able to search through the plurality of streaming events. One method of searching through the plurality of streaming events is using location data for the event/location to be streamed. The location data can be entered by the client user though input fields, or using an interactive map. Another method of searching through the plurality of streaming events is by category, such as the type of event, languages spoken, user rating, or hourly rate. Yet another method for searching through the plurality of streaming events is by providing a list or lists of the plurality of streaming events. For example, a list of businesses and streaming events can be displayed through a website homepage, or other page, wherein the client user can be directly linked to a streaming event or to a list of streaming events for a particular business. Examples of businesses and events that can be listed include, but are not limited to, hotels and resorts, assisted living, wedding halls and bridal stores, tour guides, photographers, videographers, event planners, jewelers, car showrooms, real estate, weddings, birthday parties, graduations, bar mitzvahs, and sporting events.

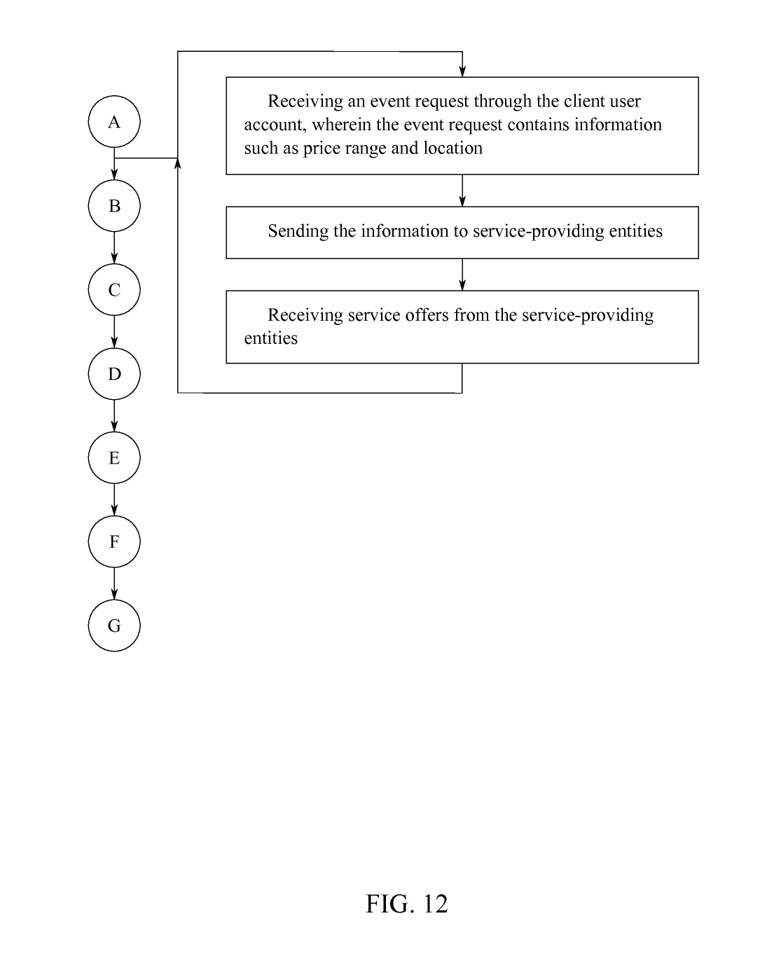

Additionally, the client user can request an event, such as a tour by providing information for certain categories, such as price range, location, special site requests, and event duration. In reference to FIG. 12, the back-end system receives the information submitted as an event request through the client user account and directs the information to the appropriate service-providing entities within the region of the event. Each of the service-providing entities in the region can then offer their services to the client user, wherein the client user can select the service-providing entity of their choice. The client user can select the service-providing entity based on cost, service rating, etc., or a combination of any factors. For example, if the client user requests a tour for a certain location, the client user may receive responses from multiple tour guides, wherein the client user can select the best tour guide based on cost, service rating, and tourist sites visited.

In reference to FIG. 1, by searching through the plurality of streaming events, the client user can make a streaming selection for a specific event. For example, the streaming selection can be for the wedding of a subsequent user, a tour of another country, or a to view a public business venture. Once the streaming selection is selected through the client user account, the streaming selection is received by the back-end system. The back-end system then schedules an event appointment between the streaming account associated with the streaming selection and the client user account. If the streaming selection is for an event hosted by a subsequent client user, then the streaming account is the subsequent client user account of the subsequent user account. If the streaming selection is for a business event or a tour, then the streaming account is the service provider account for the service-providing entity.

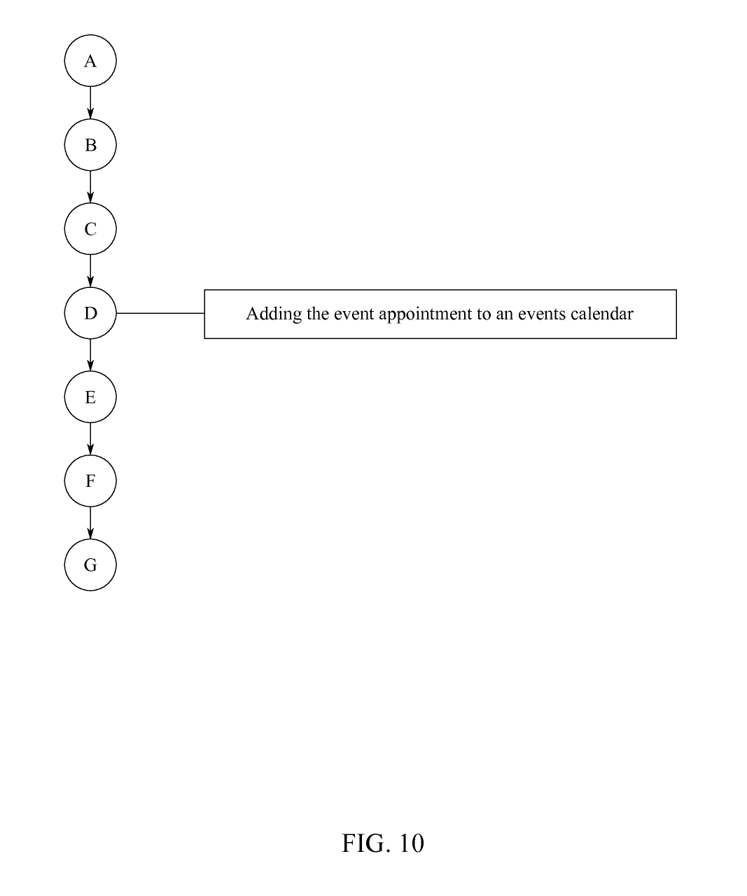

In reference to FIG. 10, as a part of scheduling the event appointment, the back-end system adds the event appointment to an events calendar for the client user. The event appointment is added to the events calendar at the date and time agreed upon by the client user and the service-providing entity or the subsequent client user. The events calendar visually organizes all of the event appointments for the client user, such that the client user can readily keep track of all appointments with both service-providing entities and subsequent client users. The event calendar also allows the client user to select the desired streaming event directly from the event calendar and proceed with displaying the live stream video feed for the streaming selection. An events calendar may also be provided for the streaming account, such that the operator of the streaming account can keep track of appointments.

An event activation code may also be used in order for the client user account to access the live stream video feed; the event activation code for each streaming event being a unique code. Upon scheduling the event appointment, the back-end system also provides the client user and the operator of the streaming account with the event activation code. The event activation code is then entered through the client user account and the streaming account at the event appointment time in order to communicably connect the client user account and the streaming account. Alternatively, the event activation code could be used only by the back-end system, wherein the event activation code is not distributed to the client user account and the streaming account. In this way, the client user and the service-providing entity only need to select the streaming event from the events calendar, and are automatically connected to one another by the back-end system.

The client user experiences the streaming event through the live stream video feed that is recorded through the streaming account. In order to accomplish this, the client user operates the client user account through the host software on a first electronic streaming device, wherein the first electronic streaming device provides means for receiving and displaying the live stream video feed. The streaming account is operated through the host software on a second electronic streaming device, wherein the second electronic streaming device provides a means for recording and transmitting the live stream video feed. For example, the first electronic streaming device could be a desktop or laptop computer and the second electronic streaming device could be a smartphone or webcam capable of transmitting video and audio.

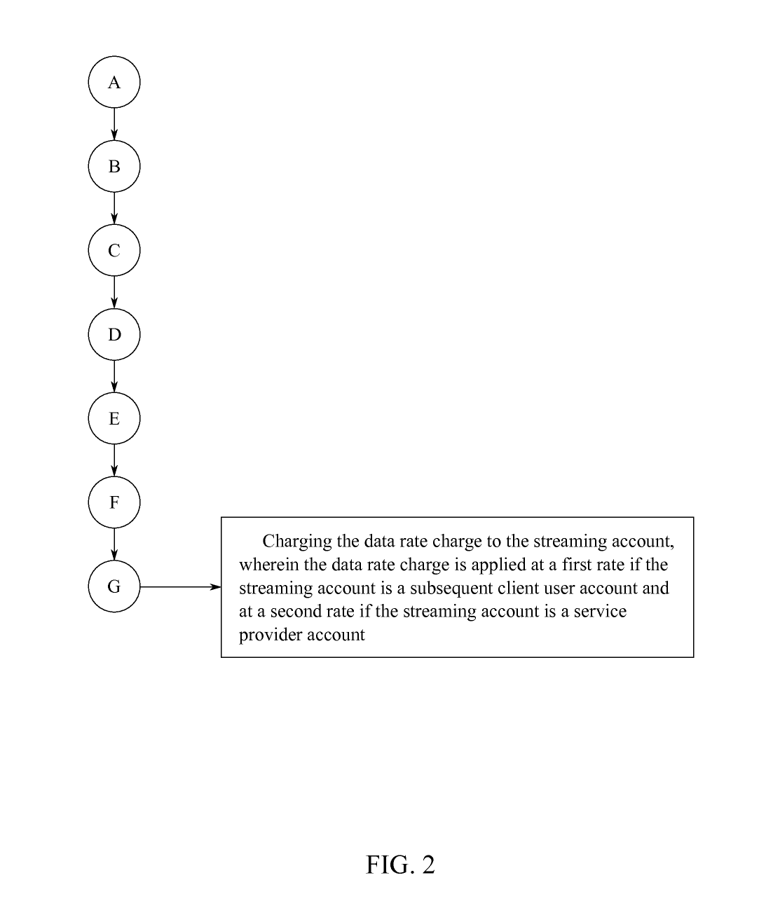

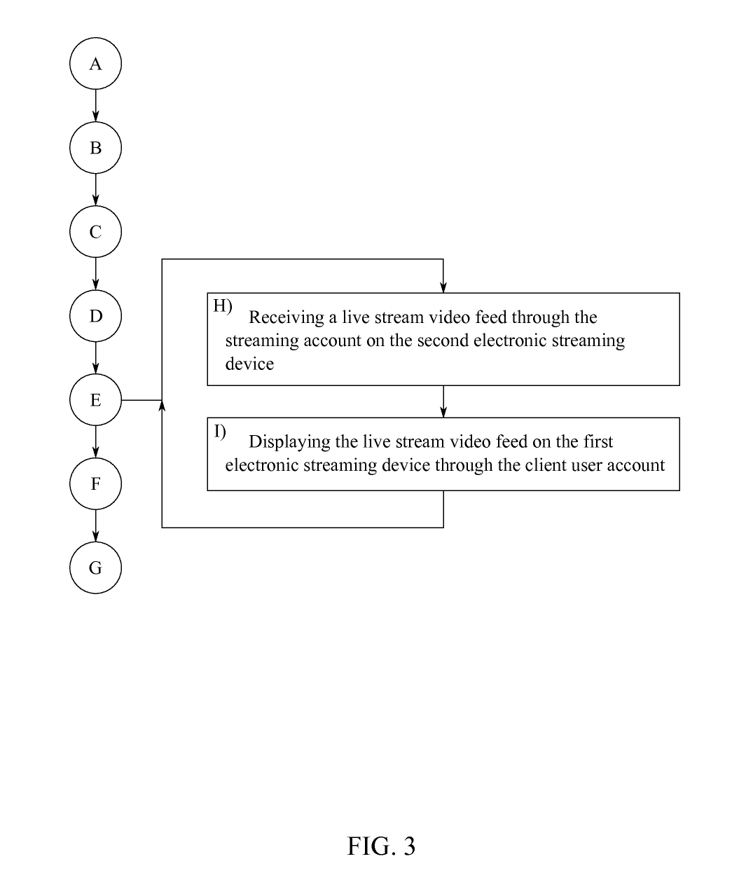

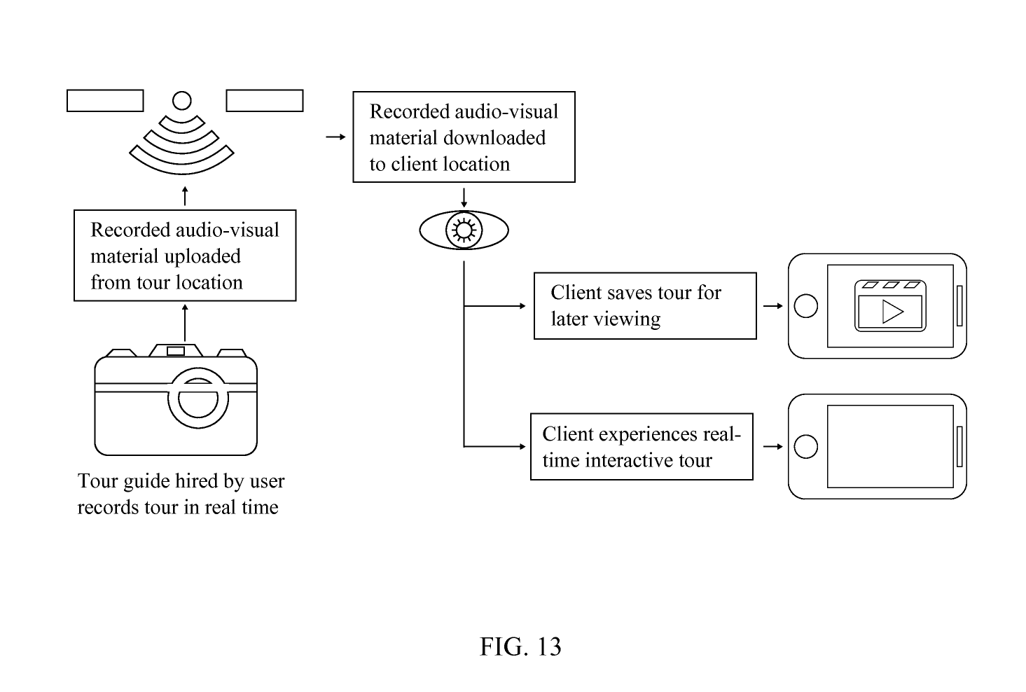

In reference to FIG. 1 and FIG. 13, the back-end system communicably connects the client user account to the streaming account through the first electronic streaming device and the second electronic streaming device, such that the client user can view the live stream video feed of the remote location. The back-end system records a connection duration for which the user account is communicably connected to the streaming account through the first electronic streaming device and the second electronic streaming device. The connection duration is used by the back-end system to apply a data rate charge to the either the client user account or the streaming account. In the preferred embodiment of the present invention, the back-end system only charges the streaming account for the data rate charge, as depicted in FIG. 2.

The data rate charge is applied per unit of time and may be charged at different rates depending on the operator of the streaming account. In reference to FIG. 2, in the preferred embodiment of the present invention, the first thirty minutes of streaming are free (i.e. the data rate charge is zero) and then the data rate charge is applied at a first rate if the streaming account is the subsequent client user account for a subsequent client user, and at a second rate if the streaming account is the service provider account for a service-providing entity. For example, the streaming account being the subsequent client user account is charged at the first rate of two cents per minute, while the streaming account being the service provider account is charged at the second rate of five cents per minute.

Ideally, the client user account is communicably connected to the streaming account in real-time. In reference to FIG. 3, the back-end system receives the live stream video feed through the streaming account on the second electronic streaming device, wherein the back-end system then displays the live stream video feed on the first electronic streaming device through the client user account. This is beneficial for streaming events such as tours, as it allows the client user to directly interact with a tour guide (eGuide) during the tour, such as to ask relevant questions about particular sites or locations. During the real-time streaming of tours, the tour guides may also be permitted to turn off the second electronic streaming device while commuting from one location to another.

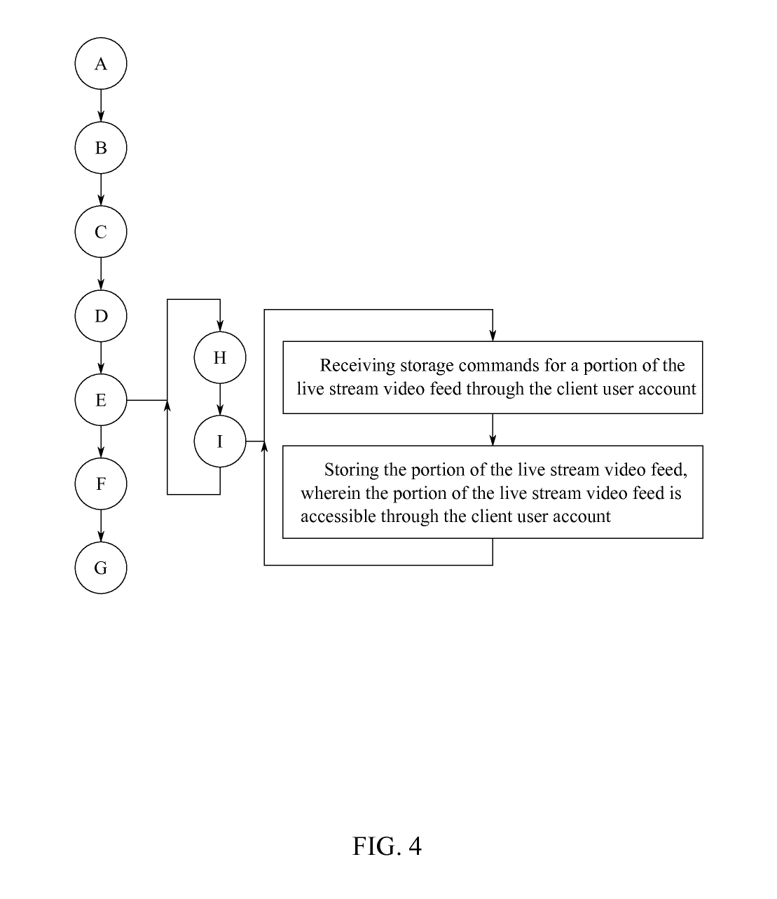

Additionally, the client user is allowed to and even encouraged to record the live stream vide feed or take screenshots of interesting landmarks and locations. This helps the client user to feel as if they physically visited the location and took pictures or video footage. In reference to FIG. 4, the client user enters storage commands through the client user account, such as selecting a time stamped section of the live stream video feed to record, or a particular moment to take a screenshot. The back-end system receives the storage commands for a portion of the live stream video feed through the client user account and then stores said portion of the live stream video feed. The portion of the live stream video feed is then accessible through the client user account to view at a later date.

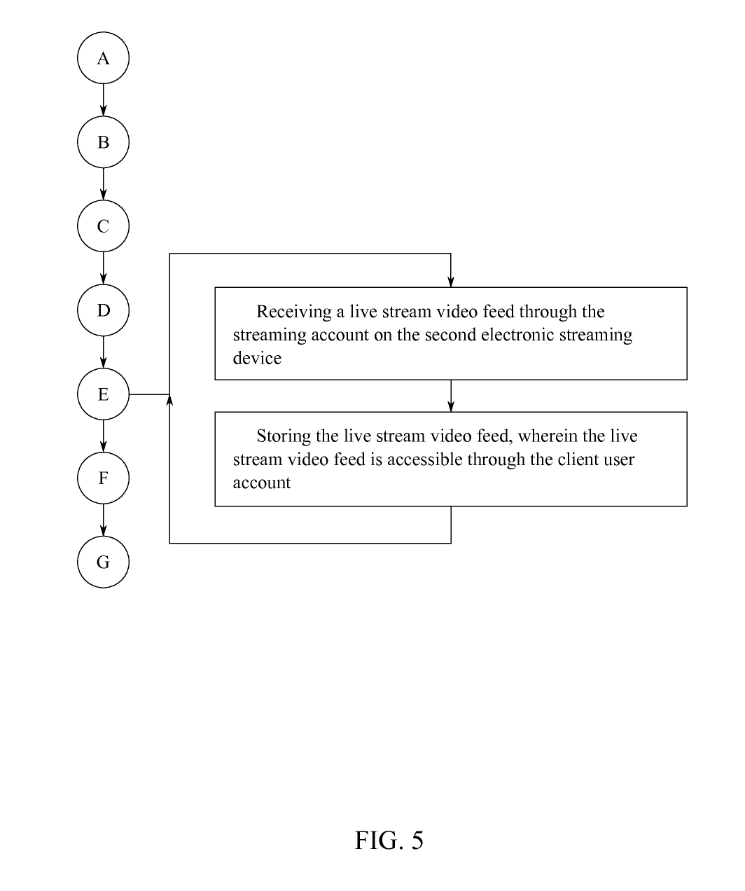

In reference to FIG. 5, it is also possible for the live stream video feed to be stored directly on the back-end system in the event that the client account cannot communicably connect to the streaming account in real-time. Similar to storing the portion of the live stream video feed, this allows the entirety of the live stream video feed to be accessible to view through the client user account at a later time. This is essentially the same as connecting to the streaming account in real-time, except that the client user cannot interactive the operator of the streaming account. This variation is beneficial if the client user has a busy schedule and finds it difficult to find time for a live tour.

A data storage fee is charged to the client user account for storing data on the back-end system. The data storage fee is applied at a price per data unit rate. In the preferred embodiment of the present invention, the first five hundred megabytes of storage is free and then the data storage fee is two dollars per gigabyte of data stored on the back-end system, however, this is subject to change in other embodiments of the present invention. The data storage fee is also applied to the service provider account for storing any data on the back-end system.

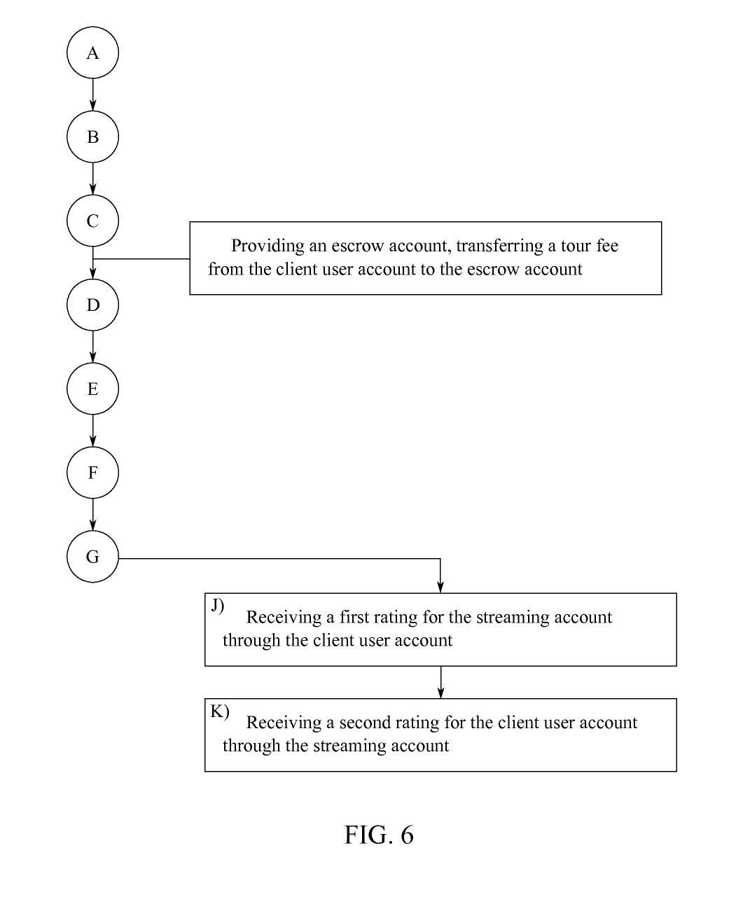

If the streaming event is a tour, then the client user must also pay a tour fee before the event appointment is scheduled, wherein the tour fee is determined by the tour guide. In reference to FIG. 6, an escrow account is provided to hold the designated funds until the tour is completed. The client user pays through the client user account, wherein the tour fee is then transferred from the client user account to the escrow account by the back-end system. Upon completing the tour, both parties are able to rate one another, wherein the back-end system receives a first rating for the streaming account through the client user account and a second rating for the user account through the streaming account. The first rating and the second rating may be on a number scale, star scale, etc. Additionally, the first rating and the second rating may include written comments.

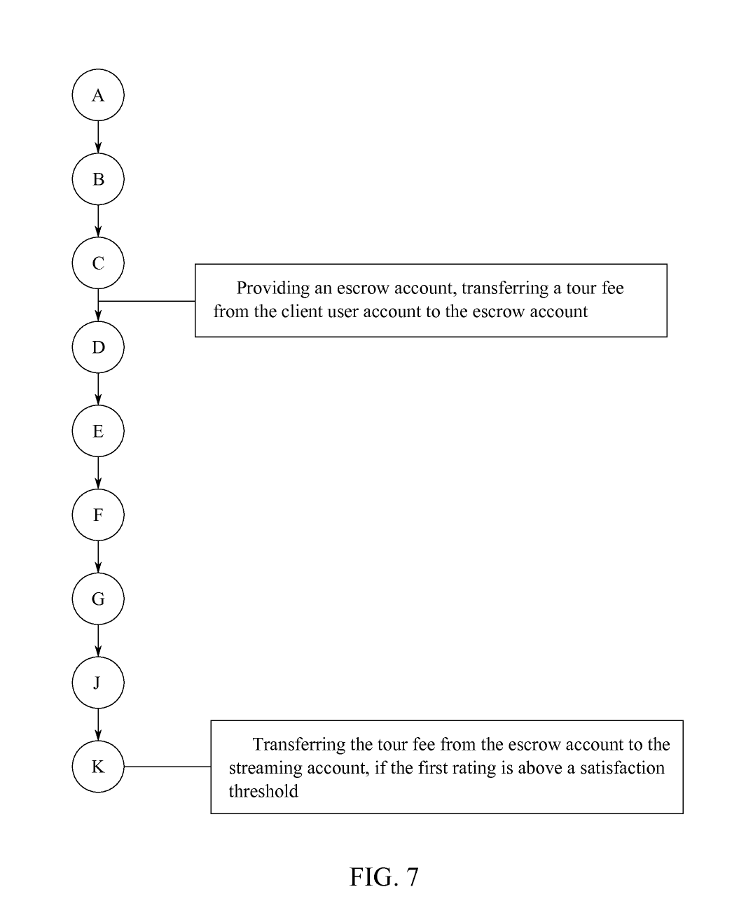

A satisfaction threshold is programmed into the back-end system in order to delegate how funds are transferred once the first rating and the second rating are received. For example, if the rating scale is one to five, then the satisfaction threshold could be three and a half, wherein anything above the satisfaction threshold constitutes a good rating and anything below constitutes a bad rating. In reference to FIG. 7, if the first rating is above the satisfaction threshold, indicating the client user was happy with their experience, the back-end system transfers the tour fee from the escrow account to the streaming account. If the first rating is below the satisfaction threshold, indicating the client user was unhappy with their experience, then an arbitration account is introduced.

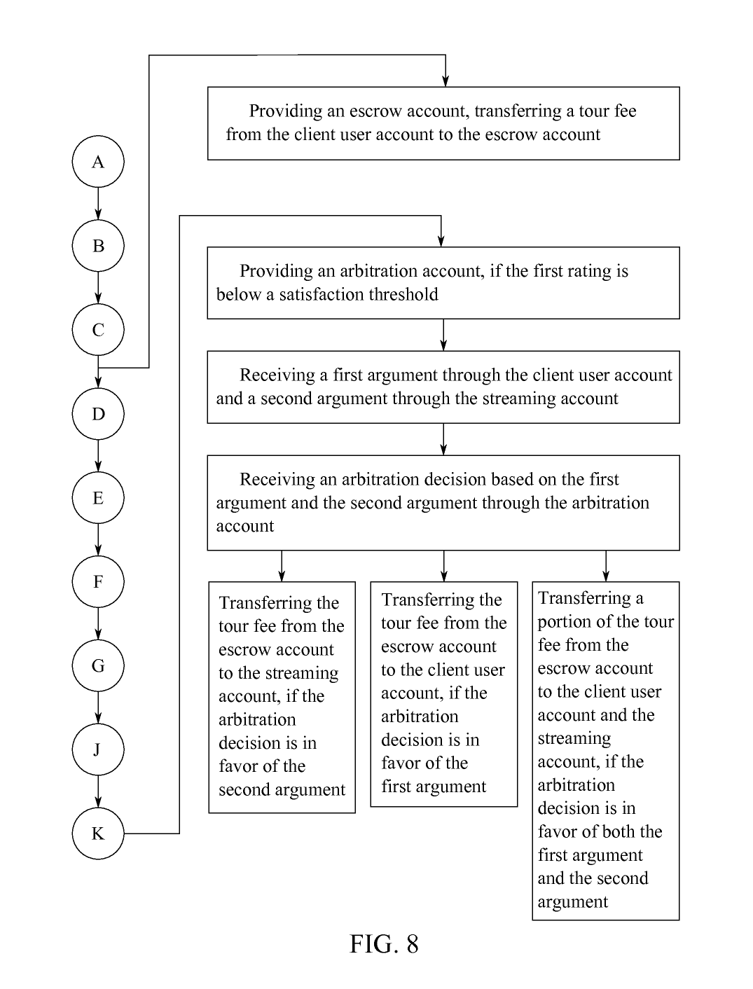

In reference to FIG. 8, the arbitration account is operated by an arbiter of the present invention, and is used to dispute claims from the client user and the tour guide. The arbiter acts as a neutral and objective party that will listen to both the client user and the tour guide. The client user is able to submit a first argument through the client user account, while the tour guide is able to submit a second argument through the streaming account. The first argument and the second argument are received by the back-end system and relayed to the arbitration account, wherein the arbiter can review both cases. The arbiter then makes an arbitration decision based on the first argument and the second argument, wherein the back-end system receives the arbitration decision through the arbitration account and distributes the funds accordingly.

In further reference to FIG. 8, if the arbitration decision is in favor of the second argument, indicating that the arbiter has sided with the tour guide, the back-end system transfers the tour fee from the escrow account to the streaming account. Additionally, any negative ratings or comments by the client user will be removed. If the arbitration decision is in favor of the first argument, indicating that the arbiter has sided with the client user, the back-end system transfers the tour fee from the escrow account to the client user account. If the arbitration decision is in favor of both the first argument and the second argument, indicating that the arbiter has sided with both the client user and the tour guide, the back-end system transfers a portion of the tour fee from the escrow account to the user account and the streaming account.

The review process is used to encourage honorable behavior from all involved parties, lest they receive negative reviews from other users. Since these evaluations are available to all users of the platform, both client users and service-providing entities are encouraged to conduct themselves in a respectful and professional manner. Those who perform or behave poorly may find that no clients wish to hire them (in the case of an unprofessional service-providing entity) or that no tour guides which to do offer tours to them (in the case of poorly behaved clients).

It is also a possible for the client user to extend the duration of a tour if it is agreed upon by the tour guide. If the tour guide agrees to extend the virtual tour, then the client user proceeds to pay an additional fee, which is transferred to the escrow account or directly to the streaming account. The additional fee may be at the same rate as the tour guide fee initially paid by the client user, or may be adjusted for overtime pay. For example, the additional fee may be charged at a rate of one and a half or two times as much as the tour guide fee originally paid. The rate of the additional fee may be adjusted at the discretion of the tour guide or an administrator of the present invention, wherein the client user should be notified of the rate prior to extending the duration of the virtual tour.

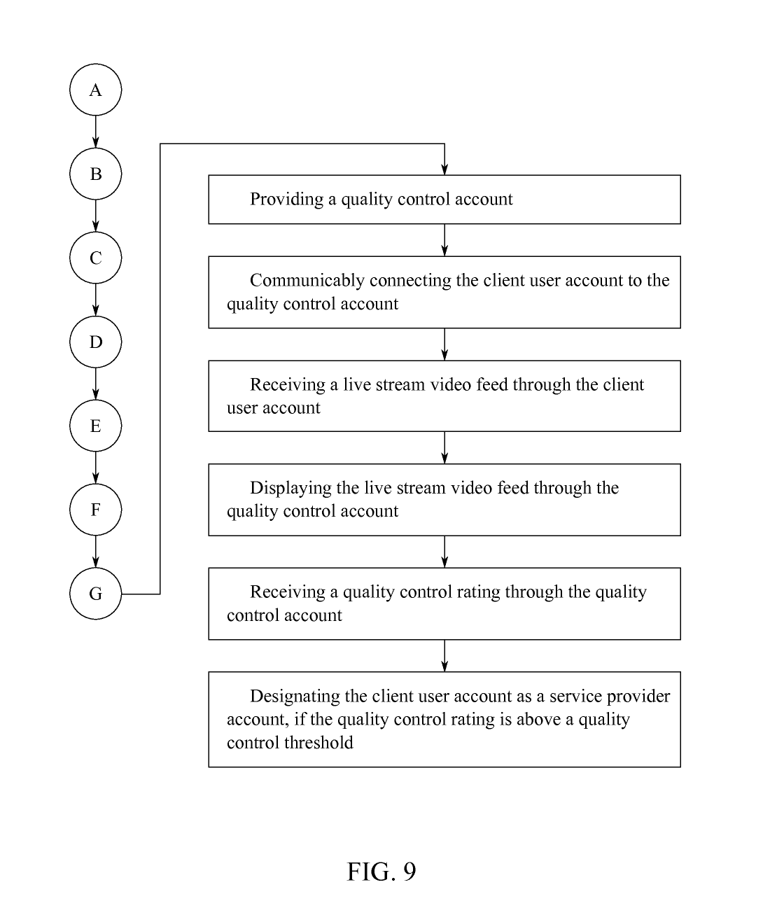

In reference to FIG. 9, the client user allows has the opportunity to become a tour guide by going through a vetting process. To initiate the vetting process, the client user contacts a quality control member of the present invention and schedules a virtual tour time. At the scheduled virtual tour time, the client user account is communicably connected to a quality control account through the back-end system, wherein the quality control account is operated by the quality control member. The back-end system receives the live stream video feed through the client user account and then displays the live stream video feed through the quality control account. The tour is provided for the quality control member in real-time, allowing the quality control member to evaluate whether or not the client user has sufficient talent and resource (e.g. video recording equipment) for providing virtual tours to paying customers.

In further reference to FIG. 9, upon completion of the tour by the client user, the quality control member determines a quality control rating for the client user. The quality control rating can be based on a number of categories rated by the quality control member, such as fluency, equipment quality, transmission quality, network quality, oratory skills, accuracy of knowledge, and attitude. A quality control threshold is programmed into the back-end system in order to determine whether or not the client user meets a minimum total rating. The back-end system receives the quality control rating through the quality control account, and if the quality control rating is above the quality control threshold, then the back-end system designates the client user account as a service provider account.

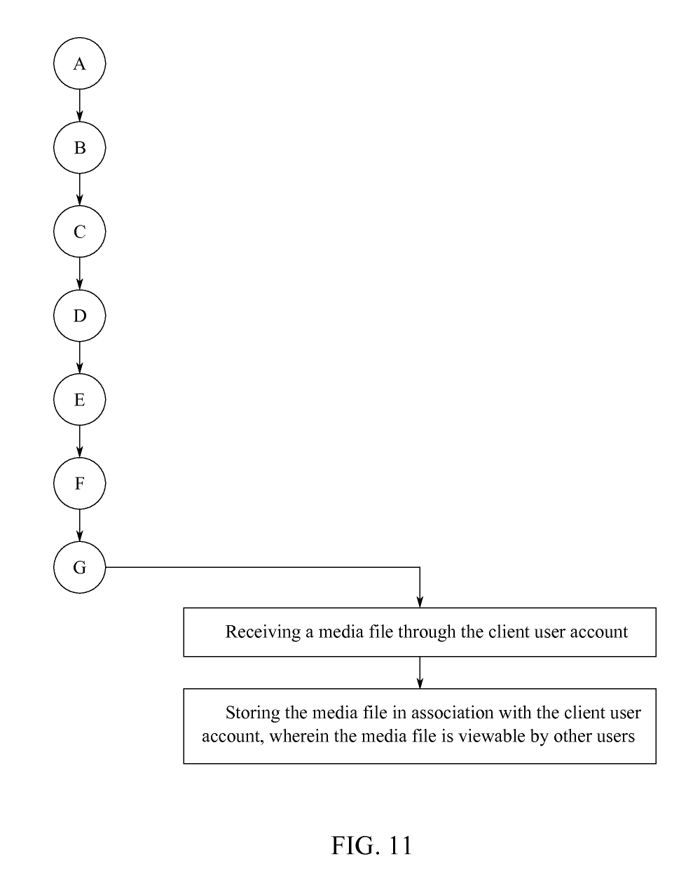

The present invention also provides social networking capabilities, wherein the client user can add friends and share information both publicly and privately. Through the client user account, the client user can upload personal information and media files, such as photos or videos. In reference to FIG. 11, when a media file is uploaded by the client user, the media file is received by the back-end system through the client user account, wherein the media file is stored on the back-end system in association with the client user account. Once the media file is uploaded, the client user can elect which of the other users of the present invention are able to view the media file.

Additionally, an interactive map is provided for the client user through the client user account. Using the interactive map, the client user can tag different locations around the world. The client user can tag in categories, such as their current location, locations they have virtually travelled to, locations they have physically traveled to, and locations that they would like to travel to in the future. Each different category is tagged in a different color in order easily visualize and distinguish the locations on the interactive map. It may also be a feature to share the interactive map with subsequent client users.

In addition to adding friends and family to share information with, the client user can choose to subscribe to service-providing entities. In this way, the client user can select a service-providing entity, such as a business or tour guide, to follow and receive updates from the service-providing entity. For example, a tour guide could distribute a list of planned tours to his to her followers, allowing the followers to automatically see upcoming tours and easily select tours to stream; any updates to the tour schedule or relevant notifications made by the tour guide would then also be automatically distributed to followers. The ability to subscribe to service-providing entities not only benefits the client user by receiving automatic updates, but is also beneficial to the service-providing entity as it allows the service providing entity to contact and update a lager client user base at one time.

Incentives may also be provided by the administrator of the present invention in order to encourage increased use of the present invention by both the client users and the service-providing entities. One such example is a rewards system for the client users and a rewards system for the service-providing entities. For example, the client user who has taken the most virtual tours over a defined period of time could be named an e-Hopper extraordinaire and maybe given credit for a free tour, free streaming, free storage etc. An example of a rewards system for the service-providing entities would be to give the tour guide who receives the highest rating for a defined period of time accolades such as promoted viewing/premium advertisement, credit for free streaming, reduced rate streaming, etc.

Beyond the core method and supporting processes, the present invention introduces additional beneficial concepts. The first is a live customer support system, using video conferencing software (as used for providing the virtual tours themselves) to connect users with customer support representatives. This live audio-visual service improves the effectiveness of customer service compared to traditional methods utilizing calls, text chat, frequently asked questions, and non-interactive video tutorials.

The present invention is also constructed to be adaptable to differences in laws across the countries of the world. To accommodate countries which restrict or prohibit certain types of communications and visual material, the present invention will disable social media settings, videos, political discussions and relevant posts, supporting only the live streaming aspect. These restrictions can be applied in a number of different methods. One example is the use of internet protocol (IP) address filtering, which blocks certain features from being accessed by IP addresses originating in a country that restricts or prohibits certain actions. Alternatively, differences in laws can be addressed by providing separate websites as necessary to comply with the laws of different countries.

Although the invention has been explained in relation to its preferred embodiment, it is to be understood that many other possible modifications and variations can be made without departing from the spirit and scope of the invention as hereinafter claimed.

What is claimed is:

1. A method for facilitating live stream feeds of remote locations by executing computer-executable instructions stored on a non-transitory computer-readable medium, the method comprises the steps of:
providing a first electronic streaming device and a second electronic streaming device, wherein a client user account is accessed on the first electronic streaming device and a streaming account is accessed on the second electronic streaming device;
displaying a plurality of streaming events through the client user account;
receiving a streaming selection from the plurality of streaming events through the client user account;
scheduling an event appointment between the streaming account associated with the streaming selection and the client user account;
communicably connecting the client user account to the streaming account through the first electronic streaming device and the second electronic streaming device;
recording a connection duration for which the client user account is communicably connected to the streaming account through the first electronic streaming device and the second electronic streaming device; and
applying a data rate charge according to the connection duration.

2. The method for facilitating live stream feeds of remote locations by executing computer-executable instructions stored on a non-transitory computer-readable medium, the method as claimed in claim 1 further comprises the steps of:
charging the data rate charge to the streaming account.

3. The method for facilitating live stream feeds of remote locations by executing computer-executable instructions stored on a non-transitory computer-readable medium, the method as claimed in claim 2, wherein the data rate charge is applied at a first rate if the streaming account is a subsequent client user account.

4. The method for facilitating live stream feeds of remote locations by executing computer-executable instructions stored on a non-transitory computer-readable medium, the method as claimed in claim 2, wherein the data rate charge is applied at a second rate if the streaming account is a service provider account.

5. The method for facilitating live stream feeds of remote locations by executing computer-executable instructions stored on a non-transitory computer-readable medium, the method as claimed in claim 1, wherein the client user account is communicably connected to the streaming account in real-time.

6. The method for facilitating live stream feeds of remote locations by executing computer-executable instructions stored on a non-transitory computer-readable medium, the method as claimed in claim 1 further comprises the steps of:
receiving a live stream video feed through the streaming account on the second electronic streaming device.

7. The method for facilitating live stream feeds of remote locations by executing computer-executable instructions stored on a non-transitory computer-readable medium, the method as claimed in claim 6 further comprises the steps of:
storing the live stream video feed, wherein the live stream video feed is accessible through the client user account.

8. The method for facilitating live stream feeds of remote locations by executing computer-executable instructions stored on a non-transitory computer-readable medium, the method as claimed in claim 6 further comprises the steps of:
displaying the live stream video feed on the first electronic streaming device through the client user account.

9. The method for facilitating live stream feeds of remote locations by executing computer-executable instructions stored on a non-transitory computer-readable medium, the method as claimed in claim 8 further comprises the steps of:
receiving storage commands for a portion of the live stream video feed through the client user account; and
storing the portion of the live stream video feed, wherein the portion of the live stream video feed is accessible through the client user account.

10. The method for facilitating live stream feeds of remote locations by executing computer-executable instructions stored on a non-transitory computer-readable medium, the method as claimed in claim 1, wherein the plurality of streaming events is searchable using location data.

11. The method for facilitating live stream feeds of remote locations by executing computer-executable instructions stored on a non-transitory computer-readable medium, the method as claimed in claim 1, wherein the plurality of streaming events is searchable by category.

12. The method for facilitating live stream feeds of remote locations by executing computer-executable instructions stored on a non-transitory computer-readable medium, the method as claimed in claim 1 further comprises the steps of:
providing an escrow account;
transferring a tour fee from the client user account to the escrow account;
receiving a first rating for the streaming account through the client user account; and
receiving a second rating for the client user account through the streaming account.

13. The method for facilitating live stream feeds of remote locations by executing computer-executable instructions stored on a non-transitory computer-readable medium, the method as claimed in claim 12 further comprises the steps of:
transferring the tour fee from the escrow account to the streaming account,
if the first rating is above a satisfaction threshold.

14. The method for facilitating live stream feeds of remote locations by executing computer-executable instructions stored on a non-transitory computer-readable medium, the method as claimed in claim 12 further comprises the steps of:
providing an arbitration account,
if the first rating is below a satisfaction threshold;
receiving a first argument through the client user account and a second argument through the streaming account; and
receiving an arbitration decision based on the first argument and the second argument through the arbitration account.

15. The method for facilitating live stream feeds of remote locations by executing computer-executable instructions stored on a non-transitory computer-readable medium, the method as claimed in claim 14 further comprises the steps of:
transferring the tour fee from the escrow account to the streaming account,
if the arbitration decision is in favor of the second argument.

16. The method for facilitating live stream feeds of remote locations by executing computer-executable instructions stored on a non-transitory computer-readable medium, the method as claimed in claim 14 further comprises the steps of:
transferring the tour fee from the escrow account to the client user account,
if the arbitration decision is in favor of the first argument.

17. The method for facilitating live stream feeds of remote locations by executing computer-executable instructions stored on a non-transitory computer-readable medium, the method as claimed in claim 14 further comprises the steps of:
transferring a portion of the tour fee from the escrow account to the client user account and the streaming account,
if the arbitration decision is in favor of both the first argument and the second argument.

18. The method for facilitating live stream feeds of remote locations by executing computer-executable instructions stored on a non-transitory computer-readable medium, the method as claimed in claim 1 further comprises the steps of:
adding the event appointment to an events calendar.

19. The method for facilitating live stream feeds of remote locations by executing computer-executable instructions stored on a non-transitory computer-readable medium, the method as claimed in claim 1 further comprises the steps of:
receiving a media file through the client user account; and
storing the media file in association with the client user account, wherein the media file is viewable by other users.

20. The method for facilitating live stream feeds of remote locations by executing computer-executable instructions stored on a non-transitory computer-readable medium, the method as claimed in claim 1 further comprises the steps of:
providing a quality control account;
communicably connecting the client user account to the quality control account;
receiving a live stream video feed through the client user account;
displaying the live stream video feed through the quality control account;
receiving a quality control rating through the quality control account; and
designating the client user account as a service provider account,
if the quality control rating is above a quality control threshold.
